(19) United States
(12) Patent Application Publication
(10) Pub. No.: US 2025/0293886 A1
(43) Pub. Date: Sep. 18, 2025

(54) METHODS FOR PROTECTION OF CHANNEL STATE INFORMATION

(71) Applicant: Cable Television Laboratories, Inc., Louisville, CO (US)

(72) Inventors: Steven J. Goeringer, Westminster, CO (US); John C. Bahr, Superior, CO (US); Igor Faynberg, East Brunswick, NY (US); Zackary Foreman, Eugene, OR (US); Joshua F. Redmore, Louisville, CO (US); Jason W. Rupe, Lafayette, CO (US); Brian A. Scriber, Lafayette, CO (US); Luther E. Smith, Fort Lupton, CO (US)

(21) Appl. No.: 19/078,780

(22) Filed: Mar. 13, 2025

Related U.S. Application Data
(60) Provisional application No. 63/564,541, filed on Mar. 13, 2024.
(60) Provisional application No. 63/724,261, filed on Nov. 22, 2024.

(51) Int. Cl. H04L 9/32; H04B 7/06

(52) U.S. Cl. CPC H04L 9/3215; H04B 7/0626

(57) ABSTRACT

A method operable by a first wireless communication device for protecting channel state information (CSI) includes (1) commencing an authentication process to authenticate a second wireless communication device, (2) inhibiting generation of CSI representing an RF channel between the first wireless communication device and the second wireless communication device, (3) after authentication of the second wireless communication device is complete, commencing an authorization process to authorize the second wireless communication device, and (4) after authorizing of the second wireless communication device is complete, enabling generation of CSI representing the RF channel between the first wireless communication device and the second wireless communication device.

### RELATED APPLICATIONS

This application claims benefit of (i) U.S. Provisional Patent Application No. 63/564,541, filed on Mar. 13, 2024, and (ii) U.S. Provisional Patent Application No. 63/724,261, filed on Nov. 22, 2024. Each of the aforementioned patent applications is incorporated herein by reference.

### BACKGROUND

Wireless communication networks using Multiple-Input Multiple-Output (MIMO) and Orthogonal Frequency Division Multiplexing (OFDM) technology commonly generate Channel State Information (CSI). CSI is a multi-dimensional matrix of values representing attenuation and phase shift of radio channel paths in a wireless communication network for each transmit and receive antenna pair for each carrier frequency. As such, CSI characterizes how wireless signals propagate from a transmitter to a receiver at each carrier frequency. CSI is used in wireless communication networks, for example, to optimize wireless communication radio channels and beamform antenna emissions. Examples of wireless communication networks that commonly use CSI include, but are not limited to, Institute of Electrical and Electronics Engineers (IEEE) 802.11 wireless communication networks (e.g., Wi-Fi wireless communication networks), Third Generation Partnership Project (3GPP) wireless communication networks (e.g., Long Term Evolution (LTE) wireless communication networks, Fifth Generation (5G) wireless communication networks, and Sixth Generation (6G) wireless communication networks), and Bluetooth wireless communication networks.

Additionally, CSI may indicate properties of an environment of a wireless communication network. In particular, in a completely static environment, e.g., with a transmitter and a receiver that are stationary in a shielded environment, CSI will have a low variability over time. In contrast, physical movement of objects within a received radio frequency (RF) path, or within a reflection of the RF path, changes attenuation and/or phase of the involved RF communication signals. Consequently, CSI may be used for wireless sensing. For example, changes in CSI may indicate movement along RF paths of a wireless communication network. Potential fidelity of wireless sensing using CSI increases with increasing frequency of RF communication signals. Accordingly, high-fidelity wireless sensing may be achieved using CSI from high frequency wireless communication networks, especially from high frequency wireless communication networks including multiple wireless transceivers. Potential applications of wireless sensing using CSI include, but are not limited to, (i) detecting presence of people, animals, or other objects, (ii) detecting activity or movement, (iii) gesture sensing, (iv) location identification, (v) medical sensing (e.g., heart rate detection and respiratory rate detection), (vi) temperature detection, (vii) fire detection, and (viii) flood detection.

### SUMMARY

Disclosed herein are new methods and associated systems for protecting confidentiality of channel state information (CSI), protecting integrity of CSI, protecting availability of CSI, protecting privacy of CSI, and/or protecting against abuse of CSI. Particular embodiments of the new methods secure creation, storage, transmission, and/or use of CSI, thereby helping prevent undesired wireless sensing, malicious interference with wireless communication network operation, and/or malicious interference with beneficial wireless sensing. For example, some embodiments produce CSI in a trusted environment and use one or more cryptographic processes to prove providence of the CSI and/or to authenticate access to the CSI. Additionally, certain embodiments encrypt CSI to help prevent unauthorized use of the CSI. Furthermore, particular embodiments support security and/or privacy of CSI in one or more of (i) a device generating CSI, (ii) link-layer peers of the device generating the CSI, (iii) network-layer peers of the device generating the CSI, and (iv) analysis of the CSI.

In an embodiment, a method operable by a first wireless communication device for protecting CSI includes (a) commencing an authentication process to authenticate a second wireless communication device, (b) inhibiting generation of CSI representing a radio frequency (RF) channel between the first wireless communication device and the second wireless communication device, and (c) after authentication of the second wireless communication device is complete, enabling generation of CSI representing the RF channel between the first wireless communication device and the second wireless communication device.

In an embodiment, a method operable by a first wireless communication device for protecting CSI includes (a) commencing an authentication process to authenticate a second wireless communication device, (b) inhibiting generation of CSI representing an RF channel between the first wireless communication device and the second wireless communication device, (c) after authentication of the second wireless communication device is complete, commencing an authorization process to authorize the second wireless communication device, and (d) after authorizing of the second wireless communication device is complete, enabling generation of CSI representing the RF channel between the first wireless communication device and the second wireless communication device.

### BRIEF DESCRIPTION OF THE DRAWINGS

FIG. 1 is a schematic diagram of a communication environment that is configured to protect Channel State Information (CSI), according to an embodiment.

FIG. 2 is a schematic diagram of an alternate embodiment of the FIG. 1 communication environment omitting signal processing functionality.

FIG. 3 is a schematic diagram of a communication environment illustrating an example of implementation of a security function by a wireless client that is configured to share CSI using a CSI reciprocity model, according to an embodiment.

FIG. 4 is a flow chart of a method for protecting CSI, according to an embodiment.

FIG. 5 is a schematic diagram of a communication environment illustrating an example of implementation of a security function by a wireless client of FIG. 1 that is configured to share CSI using a CSI feedback model, according to an embodiment.

FIG. 6 is a flow chart of another method for protecting CSI, according to an embodiment.

FIG. 7 is a schematic diagram of an embodiment of a wireless communication device of the FIG. 1 communication environment that includes a CSI enabled radio and is configured to protect CSI associated with the CSI enabled radio.

FIG. 8 is a schematic diagram of an embodiment of a wireless communication device of the FIG. 1 communication environment that includes a trusted environment where CSI is created, used, and accessed.

FIG. 9 is a schematic diagram of a communication environment illustrating an example of implementation of a security function protecting CSI and associated data transmitted between a host device and customer premises equipment (CPE).

FIG. 10 is a schematic diagram of an alternate embodiment of the FIG. 1 communication environment further including metadata accompanying CSI.

### DETAILED DESCRIPTION OF THE EMBODIMENTS

As discussed above, there are beneficial uses of Channel State Information (CSI), such as for optimizing wireless communication networks and/or for wireless sensing. However, Applicant has determined that CSI has potential to be misused, resulting in risk to individuals, risk to privacy, risk to property, and/or risk to wireless communication network operation. For example, CSI from a communication network of a person's home may be analyzed to indicate whether someone is present in the home, such as scouting the home for theft, what a person is doing in the home, and other information associated with the home that most people would expect to be secure and private. As another example, CSI used in operation of a wireless communication network could be manipulated or spoofed, such as by providing a rouge radio generating false CSI, to degrade, or even render inoperable, the wireless communication network, such as in a denial of service attack. For instance, CSI could be maliciously manipulated or spoofed to drive re-optimization thrashing of a wireless communication network, or CSI could be maliciously manipulated or spoofed to cause false signal-to-noise ratios. Additionally, manipulated or spoofed CSI may interfere with wireless communication network operation because the CSI does not represent authentic CSI sources in a wireless communication network, e.g., the CIS does not match actual checkbits, cryptographic signatures, sub-channels, and/or timing signals of the communication network.

As a further example of potential CSI misuse, CSI could be manipulated or spoofed to interfere with beneficial wireless sensing using CSI. For instance, a bad actor could provide false CSI to a security system that detects motion from CSI to cause the security system to mischaracterize movement of a burglar as other signals, to prevent the security system from detecting presence of the burglar. As another example, CSI could be manipulated or spoofed to falsely indicate a fire or other disaster, such as to divert emergency response resources from a crime scene. As a further example, a bad actor could provide false CSI to a medical monitoring system that monitors patient breathing from CSI, thereby interfering with medial monitoring of the patient.

Risk of CSI misuse is particularly acute because most households and businesses now possess communication equipment, such as Wi-Fi wireless communication network equipment, that generates and uses CSI. Additionally, conventional CSI wireless sensing systems assemble locally gathered CSI and transmit it offsite in an unprotected manner for analysis. All that is required to misuse CSI generated by conventional wireless communication networks is for one to obtain the CSI and analyze the CSI and/or manipulate the CSI. Such analysis and/or manipulation may be performed remotely and without knowledge of owners of communication equipment that generates the CSI. Furthermore, wireless sensing systems using CSI are commonly remote from premises hosting wireless communication network equipment that generates the CSI. For example, wireless sensing using CSI is frequently implemented in a cloud computing environment using CSI generated by a wireless communication device, e.g., by a Wi-Fi wireless communication device, at a customer's premises. As such, it is frequently necessary to provide CSI to a third party to enable beneficial wireless sensing, and it is possible that the third party may use the CSI for undesired purposes in addition to the beneficial wireless sensing, such as for marketing or for customer profiling, without knowledge of owners of the equipment that generates the CSI. Moreover, data that is associated with CSI, such as Wi-Fi wireless communication channel information, is also subject to misuse because this data may potentially be analyzed to perform wireless sensing.

Disclosed herein are new methods and associated systems for protecting CSI, which at least partially overcome one or more of the problems discussed above. Particular embodiments of the new methods secure creation, storage, transmission, and/or use of CSI, thereby helping prevent undesired wireless sensing, malicious interference with wireless communication network operation, and/or malicious interference with beneficial wireless sensing. For example, some embodiments produce CSI in a trusted environment and use one or more cryptographic processes to prove providence of the CSI and/or to authenticate access to the CSI. Additionally, certain embodiments encrypt CSI to help prevent unauthorized use of the CSI. Furthermore, particular embodiments of the new methods support security and/or privacy of CSI in one or more of (i) a device generating CSI, (ii) link-layer peers of the device generating the CSI, (iii) network-layer peers of the device generating the CSI, and (iv) analysis of the CSI.

Some embodiments of the new methods and associated systems implement one or more of the following 13 features:
(1) CSI information is processed and stored in a trusted execution environment.
(2) Channel settings are provided via an “on board” application program interface (API) or through hardware that can only expose CSI/channel settings to a local radio.
(3) Access to CSI or channel settings by other processes (whether local or remote) requires authentication and authorization according to a policy that is executed within the trusted execution environment.
(4) CSI information is provided to link neighbors that are approved using configuration, provisioning, or an authentication mechanism such as a Device Provisioning Protocol (DPP or EasyConnect.
(5) CSI information is provided to network layer elements that are authenticated and approved using configuration, provisioning, and/or an authentication mechanism.
(6) CSI trust is used to help assure optimization as intended. In certain embodiments, CSI trust is based on trust information on a host device or on a radio system, such as a PKI-like solution, a pre-shared secret, or a token-based authorization (such as Kerberos).
(7) A highly secure ecosystem provides a mechanism to on-board devices to a network environment, such as using a trust anchor.
(8) Integrated protection impedes altering of data such as digital signatures.
(9) CSI is digitally signed, e.g., before providing the CSI to a radio or to signal processing functionality configured to perform wireless sensing using the CSI.
(10) Requests for CSI are digitally signed.
(11) CSI information is encrypted.
(12) Mechanisms, such as a timer, are implemented to prevent re-optimization thrashing.
(13) A monitoring function is implemented to ensure that settings, such as radio channel settings, operate as intended, to help prevent impaired operation from poor CSI provided by bad actors.

While the new methods and associated systems are discussed below primarily in Wi-Fi wireless communication network applications, the new methods may be used in other wireless communication applications using Multiple-Input Multiple-Output (MIMO) and Orthogonal Frequency Division Multiplexing (OFDM) technology. For example, some embodiments of the new methods are applicable to Third Generation Partnership Project (3GPP) wireless communication networks (e.g., Long Term Evolution (LTE) wireless communication networks, Fifth Generation (5G) wireless communication networks, and Sixth Generation (6G) wireless communication networks) and Bluetooth wireless communication networks.

The new methods implement multiple security functions for protecting different respective aspects of CSI. While some embodiments of the new methods implement all of the security functions disclosed herein, it is understood that the new methods need not implement all of the security functions. Instead, the new methods may implement any one or more of the security functions disclosed herein, such as according to the needs of an application of the new methods.

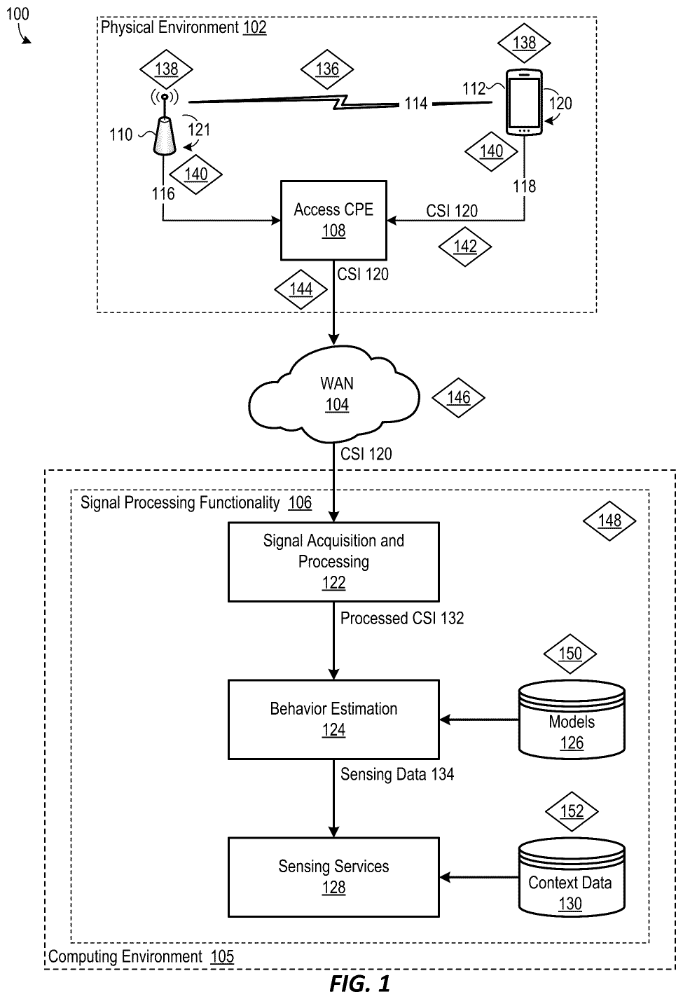

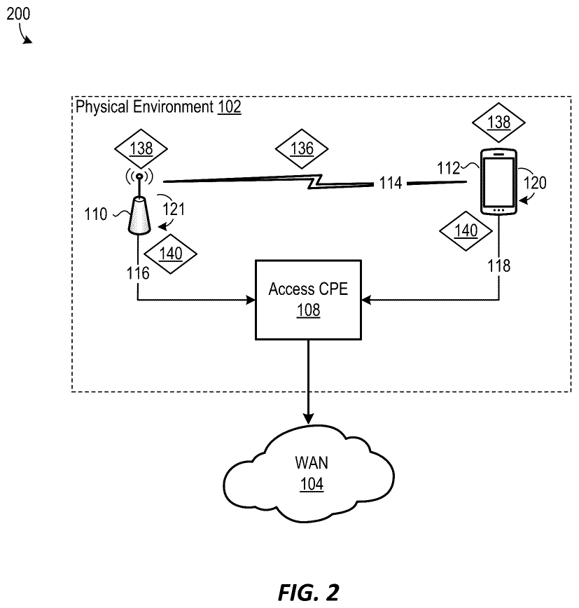

FIG. 1 is a schematic diagram of a communication environment 100 which is configured to implement certain embodiments of the new methods for protecting CSI. Communication environment 100 includes a physical environment 102, WAN 104, and a computing environment 105 hosting signal processing functionality 106. Physical environment 102 includes access customer premises equipment (CPE) 108, a wireless access point 110, and a wireless client 112. In certain embodiments of communication environment 100, the elements of physical environment 102 are located at a customer's premises, such as at a customer's home or at a customer's business. As discussed below, signal processing functionality 106 is configured to perform wireless sensing using CSI generated within physical environment 102. As such, communication environment 100 supports wireless sensing using CSI. However, some alternate embodiments of communication environment 100 omit signal processing functionality 106. For example, FIG. 2 is a schematic diagram of a communication environment 200, which is an alternate embodiment of communication environment 100 which omits signal processing functionality 106 and accordingly does not support wireless sensing.

Access CPE 108 is configured to interface communication equipment and/or user equipment with WAN 104. In some embodiments, WAN 104 includes an access communication network, a transmission communication network, and/or the Internet. Examples of WAN 104 include, but are not limited to, one or more of a cable communication network (e.g., operating according to a Data Over Cable Service Interface Specification (DOCSIS), a passive optical network (PON) communication network (e.g., an Ethernet passive optical network (EPON) communication network, a radio frequency of over glass (RFOG or RFoG) communication network, a Gigabit-capable passive optical network (GPON) communication network, an XG-PON communication network, an XGS-PON communication network, or successors of any of the foregoing optical communication networks), a digital subscriber line (DSL) communication network, a coherent optical communications network, a cellular wireless communication network (e.g., operating according to a 3GPP standard such as an LTE standard, a 5G standard, a 6G standard, or a successor of any of the foregoing standards), a powerline communication network, and a satellite wireless communications network (using very low earth orbit (VLEO) satellites, low earth orbit (LEO) satellites, medium earth orbit (MEO) satellites, or geostationary equatorial orbit (GEO) satellites). In some embodiments, access CPE 108 includes one or more of a cable modem, an optical network termination (ONT), an optical network unit (ONU), a DSL modem, a power line communication modem, and a wireless modem.

Wireless access point 110 is configured to wirelessly communicate with wireless client 112 via a radio frequency (RF) channel 114 using MIMO and OFDM technology. Although RF channel 114 is symbolically shown as a single path, RF channel 114 may, and typically will, include multiple paths in physical environment 102 between wireless client 112 and wireless access point 110. In some embodiments, wireless access point 110 is a Wi-Fi wireless access point, a cellular wireless access point (e.g., operating according to an LTE standard, a 5G standard, a 6G standard, or a successor standard), or a Bluetooth wireless access point. Although wireless client 112 is illustrated as being a mobile phone, wireless client 112 could take other forms. For example, in certain embodiments, wireless client 112 includes one or more of a computer, a set-top device, a data storage device, an Internet of Things (IoT) device, an entertainment device, a computer networking device, a smartwatch, a wearable device with wireless capability, a medical device, a security device, a monitoring device, and a wireless access device. Wireless access point 110 is communicatively coupled to access CPE 108 via a logical communication link 116, such as for data transmission between wireless access point 110 and access CPE 108, e.g., to provide backhaul for wireless access point 110. In some embodiments, logical communication link 116 is implemented by one or more of an electrical cable, an optical cable, and a wireless communication link (such as if wireless access point 110 is part of a mesh network of wireless access points). FIG. 1 further illustrates a logical communication link 118 between wireless client 112 and access CPE 108. While not required, it is anticipated that logical communication link 118 will typically be implemented by a combination of RF channel 114, wireless access point 110, and logical communication link 116.

Modifications may be made to physical environment 102 without departing from the scope hereof. For example, access CPE 108 and wireless access point 110 may be combined into a single device, such as a premises gateway. As another example, physical environment 102 may include additional wireless access points, where the additional wireless access points are configured in a mesh topology and/or are directly communicatively coupled to access CPE 108 via respective communication links. As a further example, physical environment 102 may include additional wireless clients served by wireless access point 110 and/or by additional wireless access points of physical environment 102.

Wireless access point 110 and wireless client 112 use CSI to facilitate wireless communication between each other, e.g. to determine how best transmit wireless frames between each other via RF channel 114. For example, in certain embodiments, wireless access point 110 and wireless client 112 use CSI to optimize wireless communication radio channels of RF channel 114 and/or to optimize beamform antenna emissions of wireless access point 110 and wireless client 112. FIG. 1 illustrates CSI 120 being generated by wireless client 112 and CSI 121 being generated by wireless access point 110. CSI 120 represents state of RF channel 114 from the perspective of wireless client 112 when wireless client 112 acts as a receiver, and CSI 121 represents state of RF channel 114 from the perspective of wireless access point 110 when wireless access point 110 acts as receiver. In some alternate embodiments, only one of wireless access point 110 and wireless client 112 generates CSI. For example, in certain alternate embodiments, wireless access point 110 generates CSI 121, and wireless client 112 uses CSI 121 instead of generating CSI 120. In some other alternate embodiments, wireless client 112 generates CSI 120 and wireless access point 110 uses CSI 120 instead of generating CSI 121.

Communication environment 100 is discussed below primarily with respect to protecting CSI 120 and performing wireless sensing using CSI 120. However, it is understood that the following discussion is applicable to CSI 121. For example, the protection functions discussed below with respect to protecting CSI 120 could also be applied to protecting CSI 121. As another example, signal processing functionality 106 could be modified to perform wireless sensing using CSI 121 instead of, or in addition to, using CSI 120.

CSI 120 is a matrix of complex values representing how RF wireless signals propagate along RF channel 114 from the perspective of wireless client 112 acting as a receiver, for each carrier frequency at a specified time. In some embodiments, each matrix entry of CSI 120 has a form expressed by EQN. 1 below, where H is a complex matrix entry of CSI 120, t is time, f is carrier frequency, n is a path between wireless client 112 and wireless access point 110, aᵢ is amplitude attenuation, and τᵢ is propagation delay. However, matrix entries of CSI 120 may have forms other than that expressed by EQN. 1. For example, matrix entries of CSI 120 could further account for one or more of cyclic shift diversity, sampling time offset, sampling frequency offset, and beamforming. CSI 121 may be expressed in a manner similar to CSI 120, e.g., in a manner similar to EQN. 1.

$$H ( f ; t ) = {\sum }_{n}^{N} {a}_{n} ( t ) {e}^{- j 2 π {ft}_{n} ( t )} \qquad ( EQN . 1 )$$

Wireless client 112 and wireless access point 110 need to exchange CSI, such as CSI 120 and/or CSI 121, via RF channel 114 during operation. For example, in some embodiments, wireless client 112 and wireless access point 110 use a CSI reciprocity model to provide CSI 120 to wireless access point 110 where (i) wireless access point 110 requests CSI 120 from wireless client 112, and (ii) wireless client 112 provides CSI 120 to wireless access point 110 in response to the request. As another example, in some other embodiments, wireless client 112 and wireless access point 110 use a CSI feedback model to exchange CSI 120 where wireless client 112 automatically provides CSI 120 to wireless access point 110. Similarly, a CSI reciprocity model or a CSI feedback model could be used to provide CSI 121 from wireless access point 110 to wireless client 112.

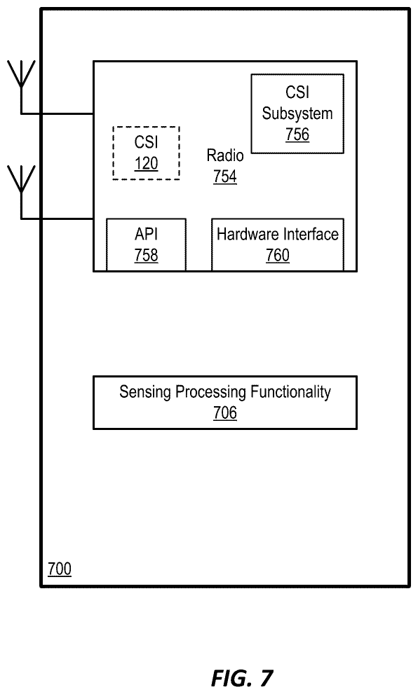

Computing environment 105 is communicatively coupled to physical environment 102 via WAN 104. As such, computing environment 105 and signal processing functionality 106 are remote from physical environment 102. In some embodiments, computing environment 105 is at least partially implemented in a distributed or cloud computing environment, such as operated by a hyperscaler. In some alternate embodiments of communication environment 100, some or all of signal processing functionality 106 is implemented in physical environment 102 instead of being hosted by computing environment 105, such that wireless sensing is at least partially locally performed in physical environment 102. For example, some or all of signal processing functionality 106 is incorporated in access CPE 108, wireless client 112, and/or wireless access point 110, in particular alternate embodiments of communication environment 100, such as discussed below with respect to FIGS. 7-9.

CSI 120 generated by wireless client 112 is transmitted to signal processing functionality 106 via logical communication link 118, access CPE 108, and WAN 104, as illustrated in FIG. 1, to enable signal processing functionality 106 to perform wireless sensing using CSI 120. Signal processing functionality 106 includes signal acquisition and processing 122, behavior estimation 124, models 126, sensing services 128, and context data 130. Signal acquisition and processing 122 generates processed CSI 132 from CSI 120, where processed CSI 132 includes some or all of CSI 120 and is in a form that facilitates wireless sensing. Behavior estimation 124 generates processed sensing data 134 from processed CSI 132 using models 126, where processed sensing data 134 represents one or more characteristics of physical environment 102 along RF channel 114. For example, processed sensing data 134 may indicate motion in physical environment 102, presence of a person or animal in physical environment 102, medical data of a person in physical environment 102, temperature of physical environment 102, presence of a fire in physical environment 102, or flooding in physical environment 102. In certain embodiments, behavior estimation 124 generates processed sensing data 134 by (i) identifying a particular model included in models 126 that most closely matches processed CSI 132 and (ii) setting processed sensing data 134 to indicate the condition (e.g., motion, presence of a person or animal, etc.) corresponding to the matching model. As discussed below, in some embodiments, models 126 are protected from unauthorized access, manipulation, and/or spoofing.

Sensing services 128 takes one or more actions based on processed sensing data 134 in accordance with context data 130. For example, assume a scenario where (i) signal processing functionality 106 is configured to perform wireless sensing for a security company monitoring physical environment 102, (ii) processed sensing data 134 indicates movement in physical environment 102 at a time when no one should be present in physical environment 102, and (iii) context data 130 indicates that an alarm should sound if motion is detected in physical environment 102 at an inappropriate time. Under this scenario, sensing services 128 would sound an alarm in response to processed sensing data 134 indicating presence of motion in physical environment 102 at the time when no one should be present in physical environment 102, as specified by context data 130. As discussed below, in certain embodiments, context data 130 is protected from unauthorized access, manipulation, and/or spoofing.

Importantly, communication environment 100 is configured to implement security functions 136, 138, 140, 142, 144, 146, 148, 150, and 152, symbolically shown by diamonds, to protect CSI 120 and CSI 121 and data associated with CSI 120 and/or CSI 121. Each security function 136, 138, 140, 142, 144, 146, 148, 150, and 152 protects a different aspect of CSI and associated data, as discussed below. The elements of communication environment 100 that implement security functions 136, 138, 140, 142, 144, 146, 148, 150, and 152 may be collectively referred to as a system for protecting CSI. Some alternate embodiments of communication environment 100 do not implement all of security functions 136, 138, 140, 142, 144, 146, 148, 150, and 152, however. For example, some alternate embodiments of communication environment 100 where WAN 104 is configured in a manner that is inherently secure do not implement security function 146. As another example, communication environment 200 (FIG. 2) does not implement security functions 142, 144, 146, 148, 150, and 152 because communication environment 200 omits signal processing functionality 106.

### Security Function 136

Security function 136 provides link-layer protection of CSI transmitted via RF channel 114 by inhibiting determination of CSI and associated optimization of RF channel 114 before a link layer peer is authenticated by a device generating CSI. For example, in particular embodiments, wireless client 112 implements security function 136 by inhibiting generation of CSI 120 until wireless access point 110 is authenticated (and optionally also authorized) by wireless client 112. As another example, in certain embodiments, wireless access point 110 implements security function 136 by inhibiting generation of CSI 121 until wireless client 112 is authenticated (and optionally also authorized) by wireless access point 110. While wireless access point 110 and wireless client 112 need CSI for optimized communication, wireless access point 110 and wireless client 112 can still communicate via RF channel 114 without CSI, albeit at reduced communication efficiency. As such, wireless access point 110 and wireless client 112 can complete an authentication process before generating CSI. Authentication of wireless access point 110 and/or wireless client 112 is performed, for example, through a challenge and response mechanism, such as Wi-Fi Protected Access (WPA) 2, WPA 3, or successors thereof, in embodiments where wireless access point 110 and wireless client 112 operate according to a Wi-Fi wireless communication standard. Additionally, authentication of wireless access point 110 and/or wireless client 112 may also be performed, for example, using a DPP, EasyConnect, or an analogous authentication mechanism, in embodiments where wireless access point 110 and wireless client 112 operate according to a Wi-Fi wireless communication standard. Furthermore, in certain embodiments, authorization of wireless access point 110 and/or wireless client 112 is performed, for example, through a secure configuration, through authorization grants (e.g., tokens or tickets provided by Oauth), through Kerberos, or through another identity mechanism. In embodiments using tokens or tickets for authorization, the tokens or tickets may be granted, for example, by a local security process or by a remote authentication and authorization (AAA) server.

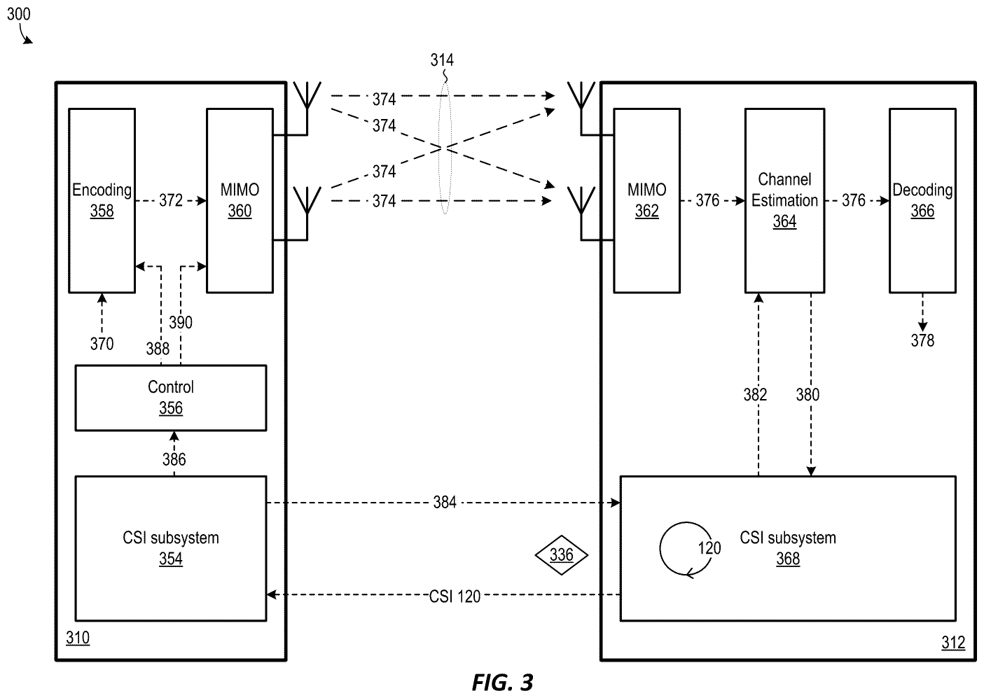

FIG. 3 is a schematic diagram of a communication environment 300 illustrating an example of implementation of security function 136 by an embodiment of wireless client 112 that is configured to share CSI 120 using a CSI reciprocity model. Communication environment 300 includes a wireless access point 310 and a wireless client 312, which are embodiments of wireless access point 110 and wireless client 112, respectively, of FIG. 1. Wireless access point 310 and wireless client 312 wirelessly communicate via an RF channel 314, which is an embodiment of RF channel 114 of FIG. 1. Wireless access point 310 includes a CSI subsystem 354, a carrier and beamforming control subsystem 356, an encoding subsystem 358, and a MIMO subsystem 360. The elements of wireless access point 310 are embodied, for example, by analog and/or digital electronic circuitry. In some embodiments, one or more elements of wireless access point 310 are at least partially embodied by a processor (not shown) of wireless access point 310 executing instructions, such as in the form of software and/or firmware, stored within a data store (not shown), such as a memory, of wireless access point 310. Wireless client 312 includes a MIMO subsystem 362, a channel estimation subsystem 364, a decoding subsystem 366, and a CSI subsystem 368. The elements of wireless client 312 are embodied, for example, by analog and/or digital electronic circuitry. In some embodiments, one or more elements of wireless client 312 are at least partially embodied by a processor (not shown) of wireless client 312 executing instructions, such as in the form of software and/or firmware, stored within a data store (not shown), such as a memory, of wireless client 312.

Each of wireless access point 310 and wireless client 312 can, and typically will, include additional elements which are not shown in FIG. 3 for illustrative simplicity. For example, while not required, wireless access point 310 will typically include a decoding subsystem in addition to encoding subsystem 358, and wireless client 312 will typically include an encoding subsystem in addition to decoding subsystem 366, to support two-way data transmission between wireless access point 310 and wireless client 312 via RF channel 314. As another example, wireless client 312 will typically include a subsystem analogous to carrier and beamforming control subsystem 356.

Encoding subsystem 358 is configured to encode data 370 to yield encoded data 372. MIMO subsystem 360 is configured to convert encoded data 372 from an electrical domain to data 374 in an RF domain for wireless transmission to wireless client 312 via RF channel 314. MIMO subsystem 362 is configured to receive data 374 via RF channel 314 and convert data 374 from the RF domain to data 376 in an electrical domain. In some embodiments, MIMO subsystem 360 and MIMO subsystem 362 are configured to support transmission of data from MIMO subsystem 362 to MIMO subsystem 360, as well as from MIMO subsystem 360 to MIMO subsystem 362, to support two-way communication. Each of channel estimation subsystem 364 and decoding subsystem 366 receives data 376 from MIMO subsystem 362. Decoding subsystem 366 is configured to decode data 376 to yield decoded data 378 for use, for example, by wireless client 312. Channel estimation subsystem 364 is configured to generate channel measurement data 380 representing measured characteristics of RF channel 314 from the perspective of wireless client 312 based on data 376. CSI subsystem 368 receives channel measurement data 380, and CSI subsystem 368 is configured to generate channel management and settings data 382 to control channel estimation subsystem 364. CSI subsystem 368 determines carrier state information from channel measurement data 380, and CSI subsystem 368 processes the determined carrier state information to generate CSI 120, as symbolically shown in FIG. 3.

CSI subsystem 368 is configured to provide CSI 120 to wireless access point 310 in response to receipt of a CSI feedback request 384 from CSI subsystem 354 of wireless access point 310. Although FIG. 3 symbolically illustrates CSI feedback request 384 and CSI 120 being transmitted between wireless access point 310 and wireless client 312 separately from RF channel 314 for illustrative clarity, each of CSI feedback request 384 and CSI 120 are transmitted via RF channel 314. CSI subsystem 354 generates channel management and settings data 386 from CSI 120, and carrier and beamforming control subsystem 356 generates each of control data 388 and control data 390 from channel management and settings data 386. Carrier and beamforming control subsystem 356 controls encoding subsystem 358 via control data 388 to optimize RF channel 314, and carrier and beamforming control subsystem 356 controls MIMO subsystem 360 via control data 390 to control beamform antenna emissions of MIMO subsystem 360.

CSI subsystem 368 implements a security function 336, which is an example of security function 136 of FIG. 1, which prevents generation of CSI 120 until wireless access point 310 is authenticated by wireless client 312. As such, security function 336 provides link layer protection of CSI 120 by preventing generation of CSI 120 representing a channel between wireless client 312 and an unauthenticated device. Additionally, in some embodiments, each of CSI feedback request 384 and CSI 120 may be digitally signed to protect their integrity, and CSI feedback request 384 and CSI 120 may also be encrypted. Wireless access point 110 could implement security function 136 in a manner similar to that illustrated in FIG. 3 by wireless access point 110 performing functions similar to that 0f wireless client 312. For example, wireless access point 110 could implement security function 136 by inhibiting generation of CSI 121 until wireless access point 110 authenticates wireless client 112.

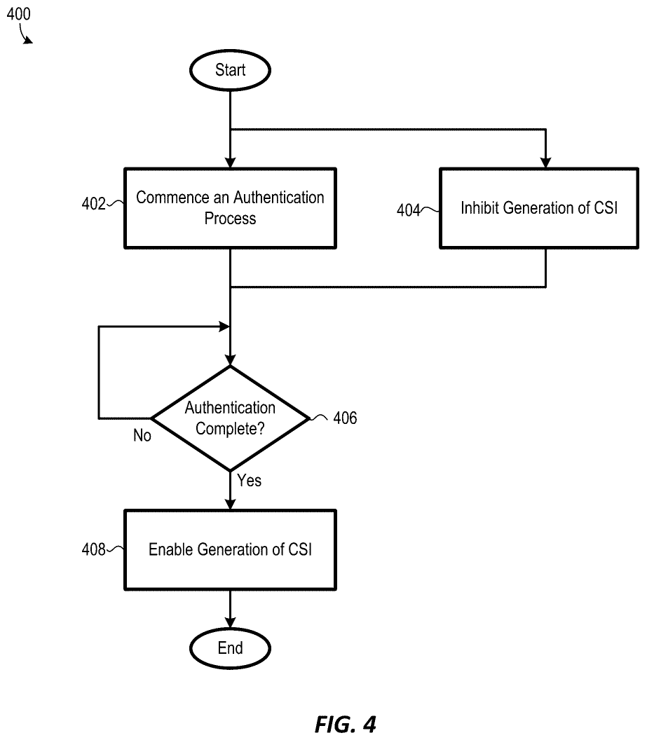

FIG. 4 is a flow chart of a method 400 for protecting channel state information which is performed by some embodiments of wireless access point 110 and/or wireless client 112. In a block 402 of method 400, a first wireless communication device commences an authentication process to authenticate a second wireless communication device. In one example of block 402, wireless client 312 commences an authentication process to authenticate wireless access point 310, e.g., using DPP or EasyConnect in embodiments where wireless access point 310 and wireless client 312 operate according to a Wi-Fi standard. In a block 404 of method 400, the first wireless communication device inhibits generation of CSI representing a RF channel between the first wireless communication device and the second wireless communication device. Block 404 is performed, for example, in parallel with block 402. In one example of block 404, CSI subsystem 368 inhibits generation of CSI 120. Blocks 402 and 404 proceed to a decision block 406 where the first wireless communication device determines whether the authentication process is complete, i.e., whether the second wireless communication device has been authenticated by the first wireless communication device. In one example of decision block 406, CSI subsystem 368 determines whether wireless client 312 has completed authentication of wireless access point 310. If the outcome of decision block 406 is no, method 400 re-executes decision block 406, optionally after a predetermined wait time (not shown). If the outcome of decision block 406 is yes, method 400 proceeds to a block 408 where the first wireless communication device enables generation of CSI of the RF channel between the first wireless communication device and the second wireless communication device. In one example of block 408, CSI subsystem 368 enables generation of CSI 120.

Method 400 assumes that authentication will be completed in due course, or stated differently, that authentication does not fail. It is understood, though, that authentication could fail, and in such case, CSI generation would remain inhibited.

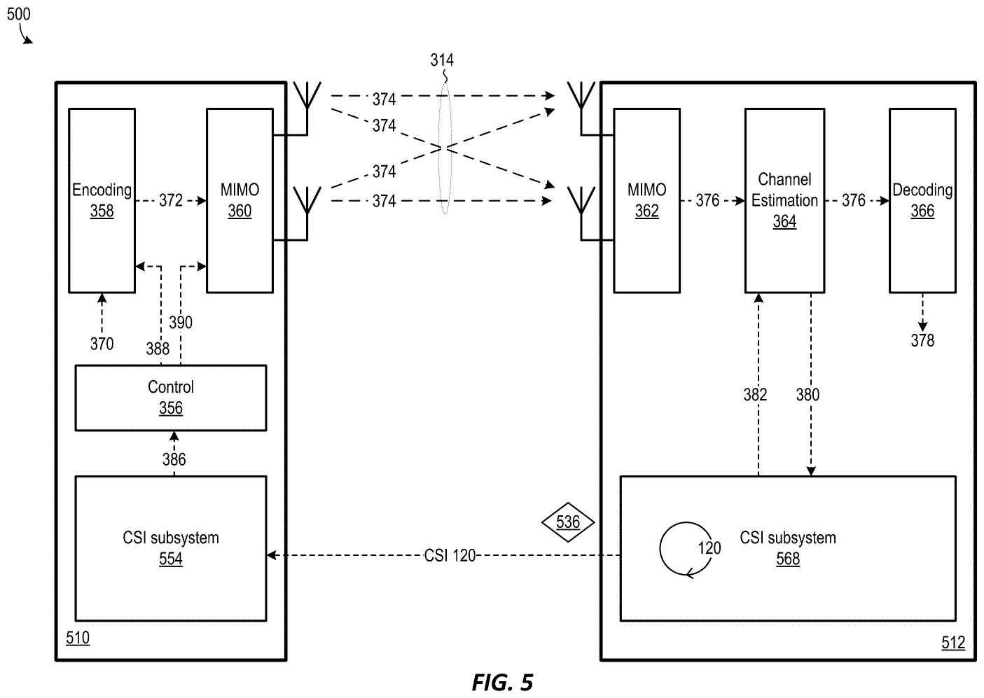

FIG. 5 is a schematic diagram of a communication environment 500 illustrating an example of implementation of security function 136 by an embodiment of wireless client 112 that is configured to share CSI 120 using a CSI feedback model. Communication environment 500 includes a wireless access point 510 and a wireless client 512, which are embodiments of wireless access point 110 and wireless client 112, respectively, of FIG. 1. Wireless access point 510 is similar to wireless access point 310 except that wireless access point 510 includes a CSI subsystem 554 in place of CSI subsystem 354. Additionally, wireless client 512 is similar to wireless client 312 except that wireless client 512 includes a CSI subsystem 568 in place of CSI subsystem 368. CSI subsystem 568 operates similarly to CSI subsystem 368 except that CSI subsystem 568 automatically provides CSI 120 to CSI subsystem 554. CSI subsystem 554 operates similarly to CSI subsystem 354 except that CSI subsystem 554 does not send CSI feedback requests 384 to CSI subsystem 568 because CSI subsystem 554 automatically receives CSI 120.

CSI subsystem 568 implements a security function 536, which is another example of security function 136 of FIG. 1, which prevents generation of CSI 120 until wireless access point 510 is both authenticated and authorized by wireless client 512. As such, security function 536 provides link layer protection of CSI 120 by preventing generation of CSI 120 representing a channel between wireless client 512 and an unauthenticated and/or unauthorized device. Furthermore, in certain embodiments, CSI subsystem 568 further protects CSI 120 by (i) encrypting CSI 120 before sending CSI 120 to wireless access point 510 to prevent unauthorized access to CSI 120 and/or (ii) digitally signing CSI 120 before sending CSI 120 to enable wireless access point 510 to ensure integrity of CSI 120. In certain embodiments, CSI subsystem 568 is configured to encrypt and/or digitally sign CSI 120 before sending CSI 120 to wireless access point 510, for example, using public-key algorithm approach (such as pre-shared asymmetric keys or Public Key Infrastructure (PKI) based attestable certificates) or using schemes as applied to other multi-user encryption models. Wireless access point 110 could implement security function 136 in a manner similar to that illustrated in FIG. 5 by wireless access point 110 performing functions similar to that of wireless client 512. For example, wireless access point 110 could implement security function 136 by inhibiting generation of CSI 121 until wireless access point 110 authenticates and authorizes wireless client 112.

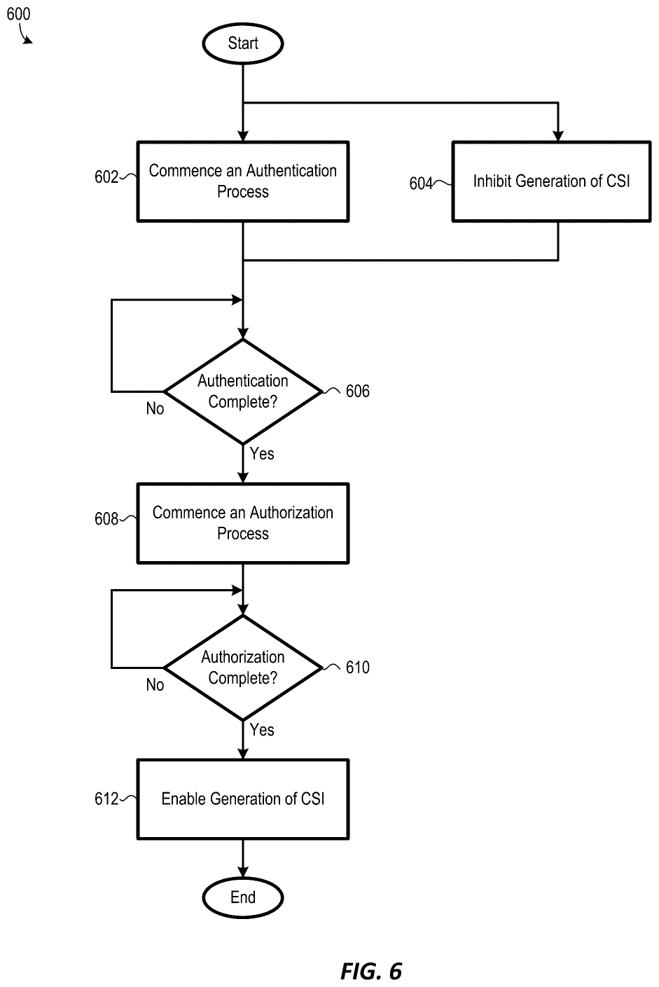

FIG. 6 is a flow chart of a method 600 for protecting channel state information which is performed by some embodiments of wireless access point 110 and/or wireless client 112. In a block 602 of method 600, a first wireless communication device commences an authentication process to authenticate a second wireless communication device. In one example of block 602, wireless client 512 commences an authentication process to authenticate wireless access point 510, e.g., using DPP or EasyConnect, in embodiments where wireless access point 510 and wireless client 512 operate according to a Wi-Fi standard. In a block 604 of method 600, the first wireless communication device inhibits generation of CSI representing a RF channel between the first wireless communication device and the second wireless communication device. Block 604 is performed, for example, in parallel with block 602. In one example of block 604, CSI subsystem 568 inhibits generation of CSI 120. Blocks 602 and 604 proceed to a decision block 606 where the first wireless communication device determines whether the authentication process is complete, i.e., whether the second wireless communication device has been authenticated by the first wireless communication device. In one example of decision block 606, CSI subsystem 568 determines whether wireless client 512 has completed authentication of wireless access point 510. If the outcome of decision block 606 is no, method 600 re-executes decision block 606, optionally after a predetermined wait time (not shown). If the outcome of decision block 606 is yes, method 600 proceeds to a block 608 where the first wireless communication device commences an authorization process to authorize the second wireless communication device. In one example of block 608, wireless client 512 commences an authorization process to authorize wireless access point 510, e.g., through a secure configuration, through authorization grants (e.g., tokens or tickets provided by Oauth), through Kerberos, or through another identity mechanism.

A decision block 610 follows block 608. In decision block 610, the first wireless communication device determines whether the authorization process is complete, i.e., whether the second wireless communication device has been authorized by the first wireless communication device. In one example of decision block 610, CSI subsystem 568 determines whether wireless client 512 has completed authorization of wireless access point 510. If the outcome of decision block 610 is no, method 600 re-executes decision block 610, optionally after a predetermined wait time (not shown). If the outcome of decision block 610 is yes, method 600 proceeds to a block 612 where the first wireless communication device enables generation of CSI of the RF channel between the first wireless communication device and the second wireless communication device. In one example of block 612, CSI subsystem 568 enables generation of CSI 120.

Method 600 assumes that authentication and authorization will be completed in due course, or stated differently, that authentication and authorization do not fail. It is understood, though, that authentication and/or authorization could fail, and in such case, CSI generation would remain inhibited.

### Security Function 138

Referring again to FIG. 1, security function 138 protects CSI (e.g., CSI 120 or CSI 121) associated with a CSI enabled radio of a host device (e.g., wireless access point 110 or wireless client 112) of physical environment 102 once the CSI is generated, irrespective of whether the CSI enabled radio is integrated with the host device or is separated from the host device. In particular, access to CSI (e.g., CSI 120 or CSI 121), or data associated with CSI data (e.g., RF channel 114 channel settings) from the CSI enabled radio, whether local to the host device or remote from the host device, requires authentication and authorization. Additionally, access to the CSI or associated data is optionally logged or otherwise tracked. In some embodiments, access to CSI and/or processed sensing data is monitored by secure logging, such as by using a digitally signed log or a secure digital ledger (e.g., based on blockchain). The host device optionally includes an API and/or other interface to enable access to CSI from a CSI enabled radio. Any CSI stored on the host and outside of CSI enabled radio is encrypted, and access to this stored CSI also requires authentication and authorization.

FIG. 7 is a schematic diagram of a wireless communication device 700 illustrating an example of implementation of security function 138. Wireless communication device 700 is, for example, an embodiment of wireless access point 110 or wireless client 112. Wireless communication device 700 can, and typically will, include additional elements that are not shown for illustrative simplicity. Wireless communication device 700 includes a radio 754 and sensing processing functionality 706. Sensing processing functionality 706 is an alternate embodiment of signal processing functionality 106 (FIG. 1) that is implemented within wireless communication device 700 instead of being external to physical environment 102. As such, wireless communication device 700 is configured to perform wireless sensing. In some alternate embodiments of wireless communication device 700, though, sensing processing functionality 706 is omitted and wireless communication device 700 is accordingly not capable of performing wireless sensing.

Radio 754 includes a CSI subsystem 756, an optional API 758, and an optional hardware interface 760. Some embodiments of radio 754 include each of API 758 and hardware interface 760, while other embodiments of radio 754 include only one of API 758 and hardware interface 760. Additionally, certain embodiments of radio 754 do not include either API 758 or hardware interface 760. CSI subsystem 756 is configured to generate CSI 120, and radio 754 is accordingly a CSI enabled radio. In some embodiments, CSI subsystem 756 is similar to CSI subsystem 368 of FIG. 3 or CSI subsystem 568 of FIG. 5. In particular embodiments, sensing processing functionality 706 is implemented by a processor (not shown) of wireless communication device 700 executing instructions, such as in the form of software and/or firmware, stored in a data store (e.g., memory) of wireless communication device 700. API 758 could be replaced with another type of interface to radio 754 without departing from the scope hereof.

API 758 and hardware interface 760, when present, each enable controlled access to CSI 120, and associated data such as RF channel 114 channel settings, within radio 754. Specifically, sensing processing functionality 706, and any other subsystem within wireless communication device 700 but outside of radio 754, may access CSI 120 within radio via API 758 or hardware interface 760, but only after the subsystem is authenticated and authorized by radio 754. API 758 and/or hardware interface 760 may also be used by a device external to wireless communication device 700 to access CSI 120 after the external device is authenticated and authorized by radio 754. Software level access to CSI 120 or channel setting information from radio 754, such as kernel level, firmware level, operating system level, or application level access, is securely provisioned and requires process controls. Authorization to access CSI 120 and/or channel setting information within radio 754 can be provided through secure configuration or through authorization grants such as tokens provide by Oauth or Kerberos. These tokens can be granted by a local security process of wireless communication device 700 or by a remote AAA server. As such, CSI 120 within radio 754 is protected from unauthorized access. In some embodiments, radio 754 digitally signs CSI 120 before sending CSI 120 to an external subsystem via API 758, hardware interface 760, and/or another interface (not shown).

### Security Function 140

Referring again to FIG. 1, security function 140 protects CSI (e.g., CSI 120 or CSI 121) by confining creation, use, and access to the CSI to a trusted environment of a host device (e.g., wireless access point 110 or wireless client 112) that cannot be accessed from the outside of the trusted environment except according to a policy that is executed within the trusted environment. Authentication and/or authorization of the host to obtain local access to the CSI data is performed, for example, using PKI, an API token, and/or another form of secret in a challenge and response. CSI stored within the trusted environment is optionally encrypted to further protect the CSI. CSI obtained from the trusted environment is optionally digitally signed by one or more subsystems within the trusted environment before the CSI leaves the trusted environment. In some embodiments, the trusted environment is capable of functioning as a server for host level access to CSI.

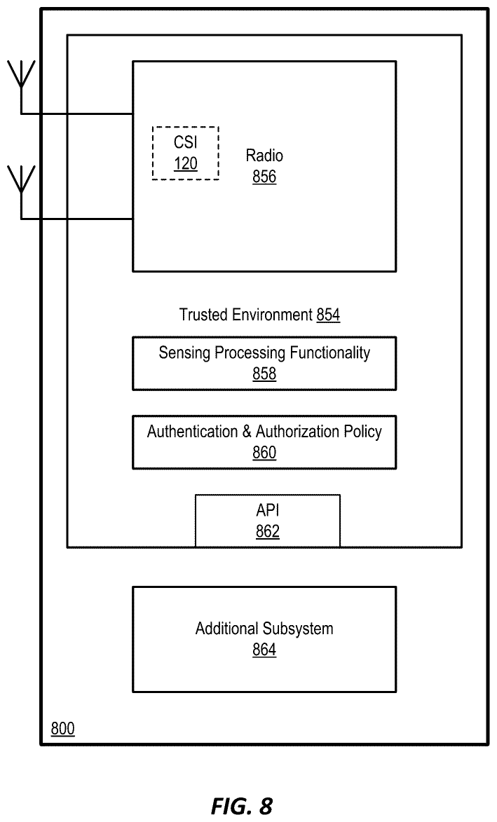

FIG. 8 is a schematic diagram of a wireless communication device 800 illustrating an example of implementation of security function 140. Wireless communication device 800 is, for example, an embodiment of wireless access point 110 or wireless client 112. Wireless communication device 800 includes a trusted environment 854 where CSI 120 is created, used, and accessed within wireless communication device 800. Trusted environment 854 includes a radio 856, sensing processing functionality 858, an authentication and authorization policy 860, and an optional API 862. Sensing processing functionality 858 is an alternate embodiment of signal processing functionality 106 (FIG. 1) that is implemented within wireless communication device 800 instead of being external to physical environment 102. As such, wireless communication device 800 is configured to perform wireless sensing. Wireless communication device 800 can, and typically will, include additional elements that are not shown for illustrative simplicity. In some embodiments, one or more of sensing processing functionality 858, authentication and authorization policy 860, and API 862 are implemented by a processor (not shown) of wireless communication device 800 executing instructions, such as in the form of software and/or firmware, stored in a data store (e.g., memory) of wireless communication device 800. API 862 could be replaced with another type of interface to trusted environment 854 without departing from the scope hereof.

Access to resources within trusted environment, (e.g., CSI 120 and associated data such as RF channel 114 channel setting information) is limited to elements within trusted environment 854, except according to authentication and authorization policy 860 that is executed within trusted environment 854. Optional API 862, when present, provides controlled access to CSI 120 and associated data to devices and processes that are authenticated and authorized by authentication and authorization policy 860. For example, additional subsystem 864, which is within wireless communication device 800 but is outside of trusted environment 854, cannot access CSI 120 except after authentication and authorization policy 860 authenticates and authorizes additional subsystem 864. As such, trusted environment 854 protects CSI 120 and associated data within wireless communication device 800.

### Security Function 142

Referring again to FIG. 1, security function 142 protects CSI and associated data transmitted between a host device (e.g., wireless access point 110 or CSI 120) and CPE (access CPE 108) in physical environment 102. CSI may be transmitted from the host device to the CPE, for example, in embodiments where wireless sensing is performed in the CPE or in embodiments where CSI must pass through the CPE to reach an external signal processing functionality (e.g., signal processing functionality 106). In certain embodiments, access to CSI on the host device must be authenticated and authorized, and optionally logged, to enable transmission of CSI and/or associated data from the host device to the CPE. In some embodiments access to CSI and/or processed sensing data is monitored by secure logging, such as by using a digitally signed log or a secure digital ledger (e.g., based on blockchain). In certain embodiments, the CPE is authenticated for the purpose of accessing CSI or associated data from the host device based on strong identity, such as PKI or similar trust anchors as applied to a Rivest-Shamir-Adleman (RSA) based procedure, a Diffie-Hellman (DH) based procedure, and/or an IEEE 802.1x based procedure, an API token, or another method of cryptographic challenge and response. Additionally, in some embodiments, the CPE is authenticated for the purpose of accessing CSI or associated data from the host device according to a predetermined policy, such as based on role of the CPE, an attribute of the CPE, nextgen-authorization of the CPE, or a secure provisioning process (e.g., using port security which identifies a link layer address, or an IP network address, that is allowed to receive CSI). CSI transmitted between the host device and the CPE is optionally encrypted and/or integrity protected (e.g., by digitally signing the CPE). In certain embodiments, transmission of CSI from the host device to the CPE is facilitated using transport layer security (TLS) or secure shell (SSH).

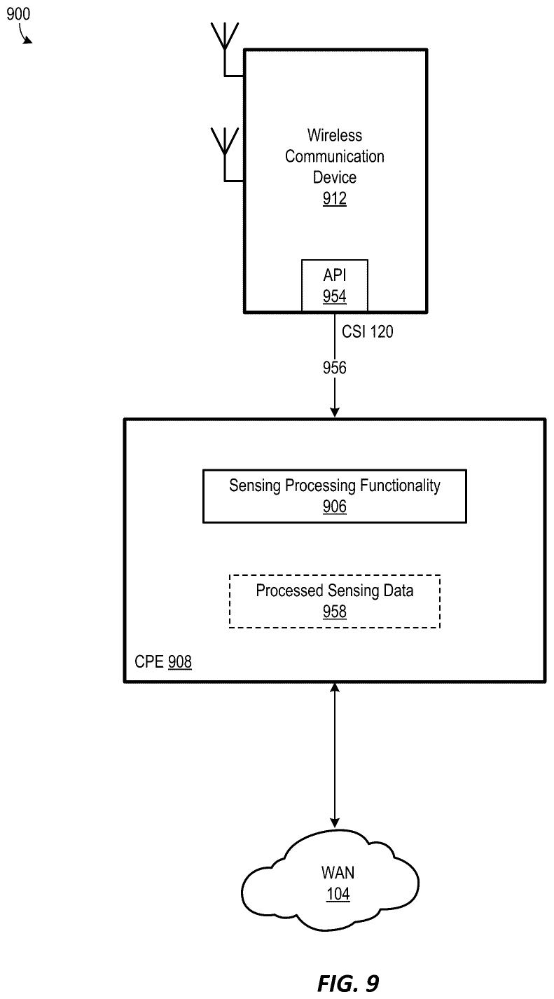

FIG. 9 is a schematic diagram of a communication environment 900 illustrating one example of implementation of security function 142. Communication environment 900 includes a host device in the form of a wireless communication device 912, CPE 908, and WAN 104. In some embodiments, wireless communication device 912 is an embodiment of wireless access point 110 or wireless client 112, and CPE 908 is an embodiment of access CPE 108.

Wireless communication device 912 includes an API 954 to provide controlled access to CSI generated within wireless communication device 912. Specifically, CSI generated within wireless communication device 912 may only be accessed via API 954 by devices that are authenticated and authorized by wireless communication device 912 to receive the CSI. CPE 908 is authorized and authenticated by wireless communication device 912 to receive CSI 120, and in response thereto, wireless communication device 912 enables transmission of CSI 120 to CPE 908 via a logical communication link 956 between API 954 and CPE 908. CPE 908 includes signal processing functionality 906, which is an alternate embodiment of signal processing functionality 106 (FIG. 1) that is implemented within CPE 908 instead of being external to physical environment 102. Accordingly, CPE 908 is configured to perform wireless sensing based on CSI 120 to generate processed sensing data 958, where processed sensing data 958 represents, for example, on or more characteristics of physical environment 102 along the path of RF channel 114. Each of wireless communication device 912 and CPE 908 can, and typically will, include additional elements that are not shown for illustrative simplicity.

### Security Function 144

Referring again to FIG. 1, security function 144 protects storage and use of CSI and processed sensing data when wireless sensing is performed within physical environment 102, such as in access CPE 108, but outside of a host device, such as outside of wireless access point 110 and wireless client 112. In particular, security function 144 limits access to CSI and processed sensing data in physical environment 102 by requiring authentication and authorization to access the processed sensing data or the CSI. For example, referring again to FIG. 9, security function 144 may be implemented by CPE 908 to protect storage and use of CSI 120 within CPE 908, as well as to protect processed sensing data 958. In some embodiments, CPE 908 implements security function 144 to require authentication and authorization using one or more of PKI, an API token, and/or another form of secret, in a challenge and response process, to access processed sensing data 958 and/or CSI 120 within CPE 908.

### Security Function 146

Referring again to FIG. 1, security function 146 protects CSI (e.g., CSI 120 or CSI 121) and any processed sensing data generated in physical environment 102 when transmitted by a wide area network, such as a WAN 104 (which may include the Internet, an access communication network, and/or a transmission communication network, as discussed above). In particular, access to CSI and processed sensing data via WAN 104 is limited to elements that are authenticated and authorized to access the CSI and processed sensing data. For instance, in some embodiments, access CPE 108 and/or another device of physical environment 102 limit access to CSI 120 and CSI 121, as well as any processed sensing data (e.g., processed sensing data 958 of FIG. 9) generated in physical environment 102, to an element that is (i) authenticated based on strong identity, such as PKI, an API token, or another method of cryptographic challenge and response, and (ii) authorized according to a predetermined appropriate policy, such as based on role of the element, an attribute of the element, nextgen-authorization of the element, or a secure provisioning process (e.g., using port security which identifies a link layer address, or an IP network address, that is allowed to receive CSI). Furthermore, in some embodiments, access to CSI and/or processed sensing data is logged, such as by using a digitally signed log or a secure digital ledger, or is otherwise monitored.

### Security Function 148

Referring again to FIG. 1, security function 148 protects CSI and associated data, such as processed sensing data, within signal processing functionality 106. For example, in particular embodiments where signal processing functionality 106 is implemented in a cloud computing environment, the cloud computing environment is protected, such as according to one or more mechanisms documented by the National Institute of Standards and Technology (NIST) and/or the Cloud Security Alliance. For example, in some embodiments, access to processed sensing data 134, CSI 120, and/or CSI 121 in signal processing functionality 106 is limited to devices to that are authenticated and authorized by signal processing functionality 106 to access processed sensing data 134, CSI 120, and/or CSI 121. Additionally, in certain embodiments, any of processed sensing data 134, CSI 120, and CSI 121 stored in signal processing functionality 106 are encrypted. Furthermore, in particular embodiments, processed sensing data 134 is digitally signed before transmitting processed sensing data 134 outside of signal processing functionality 106 to protect integrity of processed sensing data 134.

### Security Functions 150 and 152

Referring again to FIG. 1, security function 150 protects models 126, such as by limiting read access and/or write access to models 126 to devices or processes that are authenticated and are authorized to access models 126. Additionally, security function 152 protects context data 130, such as by limiting read access and/or write access to context data 130 to devices or processes that are authenticated and are authorized to access context data 130. Protecting read access to models 126 and context data 130 helps protect privacy of physical environment 102, and protecting write access to models 126 and context data 130 helps protect integrity of wireless sensing and associated action performed by signal processing functionality 106. Furthermore, in certain embodiments, security function 150 digitally signs models 126 to enable behavior estimation 124 to establish that it is accessing authentic model data, instead of spoofed or manipulated model data. Similarly, in some embodiments, security function 152 digitally signs context data 130 to enable sensing services 128 to establish that it is access authentic context data 130, instead of spoofed or manipulated context data.

### Additional Security Functions

Referring again to FIG. 1, certain embodiments of communication environment 100 implement one or more of the following additional security features to protect CSI and associated data:

(1) Certain embodiments of wireless access point 110 and/or wireless client 112 include a timer to limit rate of change to settings of their respective radios to a predetermined value, such as to prevent malicious repeated changes to radio settings, such as by a bad actor providing the radios frequently changing false CSI, that would impair communication service provided by wireless access point 110 and/or wireless client 112. The predetermined value specifies, for example, a minimum time duration between successive setting changes or a maximum frequency of setting changes.

(2) Poor radio channel settings may impair or cripple a wireless communication device, such as by degrading communication service and/or debilitating CSI gathering. Accordingly, certain embodiments of wireless access point 110 and/or wireless client 112 implement a monitoring function to ensure that their respective radio settings, such as based on CSI, function as intended, to help prevent a bad actor from impairing radio operation by providing the radio false CSI. In particular embodiments, the monitoring function causes its respective device, i.e., wireless access point 110 or wireless client 112, to switch from an operating state that uses CSI to a default operating state that does not use CSI in response to determining that the radio settings are not functioning as intended, such as in response to performance of wireless access point 110 or wireless client 112 dropping below a predetermined threshold value. Additionally, certain embodiments of wireless access point 110 and/or wireless client 112 require confirmation of radio settings and/or other assurance steps before implementing the radio settings, and certain embodiments of wireless access point 110 and/or wireless client 112 limit duration of accepted radio settings to a predetermined maximum duration, to help prevent radio impairment from false CSI.

### Metadata

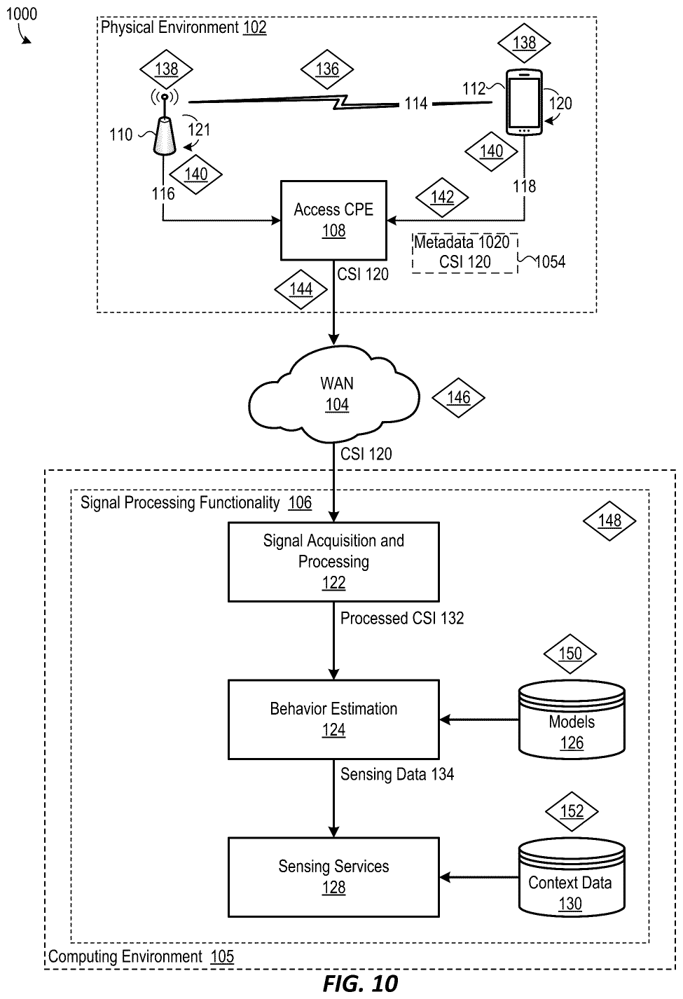

Some embodiments of communication environment 100 use metadata to indicate privacy preferences of a party associated with the CSI, such as privacy preferences of a user of wireless client 112 or privacy preferences of a subscriber to communication services of WAN 104. For example, in some embodiments, metadata is used to indicate to what extent, if at all, a user of wireless client 112 desires sharing, communication, routing, and/or aggregation of CSI 120. For example, FIG. 10 is a schematic diagram of a communication environment 1000, which is an alternate embodiment of communication environment 100 (FIG. 1) further including metadata 1020 accompanying CSI 120. Metadata 1020 specifies, for example, user preferences with respect to sharing of CSI 120, communication of CSI 120, routing of CSI 120, and/or aggregation of CSI 120. For example, metadata 1020 could indicate that (i) the user restricts sharing of CSI 120 to one or more predetermined parties or devices, (ii) the user limits communication of CSI 120 to certain predetermined communication links, (iii) the user restricts routing of CSI 120 to certain authorized communication service providers and/or (iv) the user prohibits aggregation of CSI 120.

In certain embodiments, metadata 1020 is transmitted with CSI 120 in a common payload 1054, and metadata 1020 is optionally encrypted with CSI 120 in payload 1054. Alternately, metadata 1020 may be unencrypted in common payload 1054, although CSI 120 may be encrypted in payload 1054. While FIG. 10 illustrates metadata 1020 being transmitted with CSI 120 via logical communication link 118, metadata 1020 could accompany CSI 120 along other communication paths of communication environment 1000.

In some embodiments, each device receiving metadata accompanying CSI handles the CSI in accordance with metadata. For example, assume that metadata 1020 restricts sharing of CSI 120 to solely signal processing functionality 106. In this example, access CPE 108 may restrict transmission of CSI 120 to solely signal processing functionality 106 in accordance with metadata 1020.

### Combinations of Features

Features described above may be combined in various ways without departing from the scope hereof. The following examples illustrate some possible combinations.

(A1) A method operable by a first wireless communication device for protecting channel state information (CSI) includes (1) commencing an authentication process to authenticate a second wireless communication device, (2) inhibiting generation of CSI representing a radio frequency (RF) channel between the first wireless communication device and the second wireless communication device, and (3) after authentication of the second wireless communication device is complete, enabling generation of CSI representing the RF channel between the first wireless communication device and the second wireless communication device.

(A2) The method denoted as (A1) may further include (1) generating the CSI representing the RF channel between the first wireless communication device and the second wireless communication device within a radio of the first wireless communication device and (2) requiring authentication and authorization of a subsystem that is within the first wireless communication device, but is external to the radio, to enable the subsystem to access the CSI representing the RF channel between the first wireless communication device and the second wireless communication device from the radio.

(A3) The method denoted as (A1) may further include generating the CSI representing the RF channel between the first wireless communication device and the second wireless communication device within a trusted environment of the first wireless communication device, wherein access to resources within the trusted environment is limited to elements within the trusted environment, except according to an authentication and authorization policy that is executed within the trusted environment.

(A4) Any one of the methods denoted as (A1) through (A3) may further include (1) authenticating and authorizing a customer premises equipment (CPE) to receive the CSI representing the RF channel between the first wireless communication device and the second wireless communication device and (2) in response to authenticating and authorizing the CPE, enabling transmission of the CSI representing the RF channel between the first wireless communication device and the second wireless communication device from the first wireless communication device to the CPE.

(A5) Any one of the methods denoted as (A1) through (A4) may further include (1) at customer premises equipment that is communicatively coupled to, but separate from, each of the first wireless communication device and the second wireless communication device, performing wireless sensing to generate processed sensing data representing a physical environment including the first wireless communication device and the second wireless communication device based on the CSI representing the RF channel between the first wireless communication device and the second wireless communication device, and (2) limiting access to the processed sensing data to devices that are authenticated and are authorized to access the processed sensing data.

(A6) Any one of the methods denoted as (A1) through (A5) may further include limiting access to the CSI representing the RF channel between the first wireless communication device and the second wireless communication device via a wide area network to devices that are authenticated and are authorized to access the CSI representing the RF channel between the first wireless communication device and the second wireless communication device.

(A7) Any one of the methods denoted as (A1) through (A6) may further include (1) at a communication environment that is remote from each of the first wireless communication device and the second wireless communication device, performing wireless sensing to generate processed sensing data representing a physical environment including the first wireless communication device and the second wireless communication device based on the CSI representing the RF channel between the first wireless communication device and the second wireless communication device, and (2) limiting access to the processed sensing data to devices that are authenticated and are authorized to access the processed sensing data.

(A8) Any one of the methods denoted as (A1) through (A7) may further include limiting a rate of change of settings to a radio of the first wireless communication device to a predetermined value.

(A9) In any one of the methods denoted as (A1) through (A8), each of the first wireless communication device and the second wireless communication device may be a Wi-Fi wireless communication device.

(B1) A method operable by a first wireless communication device for protecting CSI includes (1) commencing an authentication process to authenticate a second wireless communication device, (2) inhibiting generation of CSI representing an RF channel between the first wireless communication device and the second wireless communication device, (3) after authentication of the second wireless communication device is complete, commencing an authorization process to authorize the second wireless communication device, and (4) after authorizing of the second wireless communication device is complete, enabling generation of CSI representing the RF channel between the first wireless communication device and the second wireless communication device.

(B2) The method denoted as (B1) may further include encrypting CSI representing the RF channel between the first wireless communication device and the second wireless communication device before sending the CSI to the second wireless communication device.

(B3) Either one of the methods denoted as (B1) and (B2) may further include digitally signing CSI representing the RF channel between the first wireless communication device and the second wireless communication device before sending the CSI to the second wireless communication device.

(B4) Any one of the methods denoted as (B1) through (B3) may further include (1) generating the CSI representing the RF channel between the first wireless communication device and the second wireless communication device within a radio of the first wireless communication device and (2) requiring authentication and authorization of a subsystem that is within the first wireless communication device, but is external to the radio, to enable the subsystem to access the CSI representing the RF channel between the first wireless communication device and the second wireless communication device from the radio.

(B5) Any one of the methods denoted as (B1) through (B3) may further include generating the CSI representing the RF channel between the first wireless communication device and the second wireless communication device within a trusted environment of the first wireless communication device, wherein access to resources within the trusted environment is limited to elements within the trusted environment, except according to an authentication and authorization policy that is executed within the trusted environment.

(B6) Any one of the methods denoted as (B1) through (B5) may further include (1) authenticating and authorizing customer premises equipment (CPE) to receive the CSI representing the RF channel between the first wireless communication device and the second wireless communication device and (2) in response to authenticating and authorizing the CPE, enabling transmission of the CSI representing the RF channel between the first wireless communication device and the second wireless communication device from the first wireless communication device to the CPE.

(B7) Any one of the methods denoted as (B1) through (B6) may further include (1) at customer premises equipment that is communicatively coupled to, but separate from, each of the first wireless communication device and the second wireless communication device, performing wireless sensing to generate processed sensing data representing a physical environment including the first wireless communication device and the second wireless communication device based on the CSI representing the RF channel between the first wireless communication device and the second wireless communication device, and (2) limiting access to the processed sensing data to devices that are authenticated and are authorized to access the processed sensing data.

(B8) Any one of the methods denoted as (B1) through (B7) may further include limiting access to the CSI representing the RF channel between the first wireless communication device and the second wireless communication device via a wide area network to devices that are authenticated and are authorized to access the CSI representing the RF channel between the first wireless communication device and the second wireless communication device.

(B9) Any one of the methods denoted as (B1) through (B8) may further include (1) at a communication environment that is remote from each of the first wireless communication device and the second wireless communication device, performing wireless sensing to generate processed sensing data representing a physical environment including the first wireless communication device and the second wireless communication device based on the CSI representing the RF channel between the first wireless communication device and the second wireless communication device, and (2) limiting access to the processed sensing data to devices that are authenticated and are authorized to access the processed sensing data.

(B10) Any one of the methods denoted as (B1) through (B9) may further include causing the first wireless communication device to switch from (i) an operating state using the CSI representing the RF channel between the first wireless communication device and the second wireless communication device to (ii) a default operating state that does not use the CSI representing the RF channel between the first wireless communication device and the second wireless communication device, in response to performance of the first wireless communication device dropping below a predetermined threshold value.

(B11) In any one of the methods denoted as (B1) through (B10), each of the first wireless communication device and the second wireless communication device may be a Wi-Fi wireless communication device.

Changes may be made in the above methods, devices, and systems without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and system, which as a matter of language, might be said to fall therebetween.

What is claimed is:

1. A method operable by a first wireless communication device for protecting channel state information (CSI), the method comprising:
commencing an authentication process to authenticate a second wireless communication device;
inhibiting generation of CSI representing a radio frequency (RF) channel between the first wireless communication device and the second wireless communication device; and
after authentication of the second wireless communication device is complete, enabling generation of CSI representing the RF channel between the first wireless communication device and the second wireless communication device.

2. The method of claim 1, further comprising:
generating the CSI representing the RF channel between the first wireless communication device and the second wireless communication device within a radio of the first wireless communication device; and
requiring authentication and authorization of a subsystem that is within the first wireless communication device, but is external to the radio, to enable the subsystem to access the CSI representing the RF channel between the first wireless communication device and the second wireless communication device from the radio.

3. The method of claim 1, further comprising generating the CSI representing the RF channel between the first wireless communication device and the second wireless communication device within a trusted environment of the first wireless communication device, wherein access to resources within the trusted environment is limited to elements within the trusted environment, except according to an authentication and authorization policy that is executed within the trusted environment.

4. The method of claim 1, further comprising:
authenticating and authorizing a customer premises equipment (CPE) to receive the CSI representing the RF channel between the first wireless communication device and the second wireless communication device; and
in response to authenticating and authorizing the CPE, enabling transmission of the CSI representing the RF channel between the first wireless communication device and the second wireless communication device from the first wireless communication device to the CPE.

5. The method of claim 1, further comprising:
at customer premises equipment that is communicatively coupled to, but separate from, each of the first wireless communication device and the second wireless communication device, performing wireless sensing to generate processed sensing data representing a physical environment including the first wireless communication device and the second wireless communication device based on the CSI representing the RF channel between the first wireless communication device and the second wireless communication device; and
limiting access to the processed sensing data to devices that are authenticated and are authorized to access the processed sensing data.

6. The method of claim 1, further comprising limiting access to the CSI representing the RF channel between the first wireless communication device and the second wireless communication device via a wide area network to devices that are authenticated and are authorized to access the CSI representing the RF channel between the first wireless communication device and the second wireless communication device.

7. The method of claim 1, further comprising:
at a communication environment that is remote from each of the first wireless communication device and the second wireless communication device, performing wireless sensing to generate processed sensing data representing a physical environment including the first wireless communication device and the second wireless communication device based on the CSI representing the RF channel between the first wireless communication device and the second wireless communication device; and
limiting access to the processed sensing data to devices that are authenticated and are authorized to access the processed sensing data.

8. The method of claim 1, further comprising limiting a rate of change of settings to a radio of the first wireless communication device to a predetermined value.

9. The method of claim 1, wherein each of the first wireless communication device and the second wireless communication device is a Wi-Fi wireless communication device.

10. A method operable by a first wireless communication device for protecting channel state information (CSI), the method comprising:
commencing an authentication process to authenticate a second wireless communication device;
inhibiting generation of CSI representing a radio frequency (RF) channel between the first wireless communication device and the second wireless communication device;
after authentication of the second wireless communication device is complete, commencing an authorization process to authorize the second wireless communication device; and
after authorizing of the second wireless communication device is complete, enabling generation of CSI representing the RF channel between the first wireless communication device and the second wireless communication device.

11. The method of claim 10, further comprising encrypting CSI representing the RF channel between the first wireless communication device and the second wireless communication device before sending the CSI to the second wireless communication device.

12. The method of claim 10, further comprising digitally signing CSI representing the RF channel between the first wireless communication device and the second wireless communication device before sending the CSI to the second wireless communication device.

13. The method of claim 10, further comprising:
generating the CSI representing the RF channel between the first wireless communication device and the second wireless communication device within a radio of the first wireless communication device; and
requiring authentication and authorization of a subsystem that is within the first wireless communication device, but is external to the radio, to enable the subsystem to access the CSI representing the RF channel between the first wireless communication device and the second wireless communication device from the radio.

14. The method of claim 10, further comprising generating the CSI representing the RF channel between the first wireless communication device and the second wireless communication device within a trusted environment of the first wireless communication device, wherein access to resources within the trusted environment is limited to elements within the trusted environment, except according to an authentication and authorization policy that is executed within the trusted environment.

15. The method of claim 10, further comprising:
authenticating and authorizing customer premises equipment (CPE) to receive the CSI representing the RF channel between the first wireless communication device and the second wireless communication device; and
in response to authenticating and authorizing the CPE, enabling transmission of the CSI representing the RF channel between the first wireless communication device and the second wireless communication device from the first wireless communication device to the CPE.

16. The method of claim 10, further comprising:
at customer premises equipment that is communicatively coupled to, but separate from, each of the first wireless communication device and the second wireless communication device, performing wireless sensing to generate processed sensing data representing a physical environment including the first wireless communication device and the second wireless communication device based on the CSI representing the RF channel between the first wireless communication device and the second wireless communication device; and
limiting access to the processed sensing data to devices that are authenticated and are authorized to access the processed sensing data.

17. The method of claim 10, further comprising limiting access to the CSI representing the RF channel between the first wireless communication device and the second wireless communication device via a wide area network to devices that are authenticated and are authorized to access the CSI representing the RF channel between the first wireless communication device and the second wireless communication device.

18. The method of claim 10, further comprising:
at a communication environment that is remote from each of the first wireless communication device and the second wireless communication device, performing wireless sensing to generate processed sensing data representing a physical environment including the first wireless communication device and the second wireless communication device based on the CSI representing the RF channel between the first wireless communication device and the second wireless communication device; and
limiting access to the processed sensing data to devices that are authenticated and are authorized to access the processed sensing data.

19. The method of claim 10, further comprising causing the first wireless communication device to switch from (i) an operating state using the CSI representing the RF channel between the first wireless communication device and the second wireless communication device to (ii) a default operating state that does not use the CSI representing the RF channel between the first wireless communication device and the second wireless communication device, in response to performance of the first wireless communication device dropping below a predetermined threshold value.

20. The method of claim 10, wherein each of the first wireless communication device and the second wireless communication device is a Wi-Fi wireless communication device.
